(19) United States
(12) Patent Application Publication
(10) Pub. No.: US 2013/0081246 A1
(43) Pub. Date: Apr. 4, 2013

(54) SYSTEMS AND METHODS FOR IN-PROCESS NON-CONTACT OPTICAL SURFACE ROUGHNESS MEASUREMENT

(71) Applicants: Wayne Case, Portland, OR (US); Glenn Valliant, Costa Mesa, CA (US)

(72) Inventors: Wayne Case, Portland, OR (US); Glenn Valliant, Costa Mesa, CA (US)

(73) Assignee: SCHMITT INDUSTRIES, INC., Portland, OR (US)

(21) Appl. No.: 13/251,964

(22) Filed: Oct. 3, 2011

(51) Int. Cl. B23Q 17/00; B23P 21/00

(52) U.S. Cl. 29/407.01; 29/705

(57) ABSTRACT

A system for measuring the roughness of a target surface in a manufacturing line is disclosed. Particularly, in some embodiments, the system may include a manufacturing line configured to provide movement of the target surface through a manufacturing process, a non-contact optical surface roughness measurement device configured to measure the surface roughness of the target surface on the manufacturing line, and a control system communicatively coupled with the non-contact optical surface roughness measurement device configured to receive an indication of a measured surface roughness of the target surface.

### TECHNICAL FIELD

This disclosure relates generally to measuring of surface roughnesses and, more particularly, to systems and methods for in-process non-contact optical surface roughness measurement.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a block diagram of a non-contact optical surface roughness measurement device consistent with embodiments disclosed herein;

FIG. 2 illustrates a block diagram of an in-process non-contact optical surface roughness measurement system consistent with embodiments disclosed herein; and

FIG. 3 illustrates a block diagram of an in-process non-contact optical surface roughness measurement system configured to measure a continuous sheet of material consistent with embodiments disclosed herein;

FIG. 4 illustrates a block diagram of an in-process non-contact optical surface roughness measurement system configured to measure a continuous wire consistent with embodiments disclosed herein;

FIG. 5 illustrates a flow diagram of an exemplary method for in-process non-contact optical surface roughness measurement consistent with embodiments disclosed herein;

FIG. 6 illustrates a screenshot of a display of an external control system for an in-process non-contact optical surface roughness measurement device consistent with embodiments disclosed herein;

FIG. 7 illustrates another screenshot display of an external control system for an in-process non-contact optical surface roughness measurement device consistent with embodiments disclose herein;

FIG. 8 illustrates a non-contact optical surface roughness measurement device affixed to a adjustable mount consistent with embodiments disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Maintaining surface roughness within certain tolerances is an important consideration in the manufacture of many materials and devices. For example, manufacturing sheet metal may require that the surface of the metal have no greater than a certain level of surface roughness based on manufacturing specifications. Consistent with embodiments disclosed herein, devices capable of measuring surfaces roughness during the manufacturing process (i.e., in-process) may be used to verify that materials and devices are manufactured within tolerances and to ensure manufacturing equipment is operating. Moreover, measuring surface roughness in-process may allow for the in-process removal of materials and devices measured as out-of-specification tolerances.

Devices for measuring surface roughness include mechanical surface contact-type stylus profilometers and surface non-contact optical profilometers. These conventional surface roughness measuring devices have several drawbacks, however, including potentially damaging a surface during a measurement, high cost, relatively slow measurement speed, lack of portability, sensitivity to environmental conditions, and lack of a direct way to compare measured surfaces to known surface roughness standards. For example, conventional surface roughness measurement devices may physically damage softer materials (e.g., copper foil). Moreover, in view of their relatively slow measurement speed, mechanical surface contact-type profilometers may not be ideal for in-process measurement and control of multiple target surfaces in a manufacturing processes. In addition, conventional surface roughness measurement devices may require that a measurement surface remain motionless relative to the measurement device and/or removal of the measurement surface from a manufacturing line.

More sophisticated surface non-contact optical devices for measuring surface roughness, including devices that measure the distribution of reflected (i.e., specular) light and scattered light from a surface and use the measured distribution to calculate surface roughness, offer advantages over conventional mechanical surface roughness measurement devices. For example, the optical surface roughness measuring device described in U.S. Pat. No. 5,608,527 (“the '527 patent”), which is herein incorporated by reference in its entirety, allows for precise surface roughness measurement but does not damage a measured surface, is fast and portable, and is less sensitive to environmental conditions and damage from normal handling. Such a non-contact optical surface roughness measurement device may be designed and integrated into a manufacturing system allowing for in-process measurement and process control of target surface roughness levels.

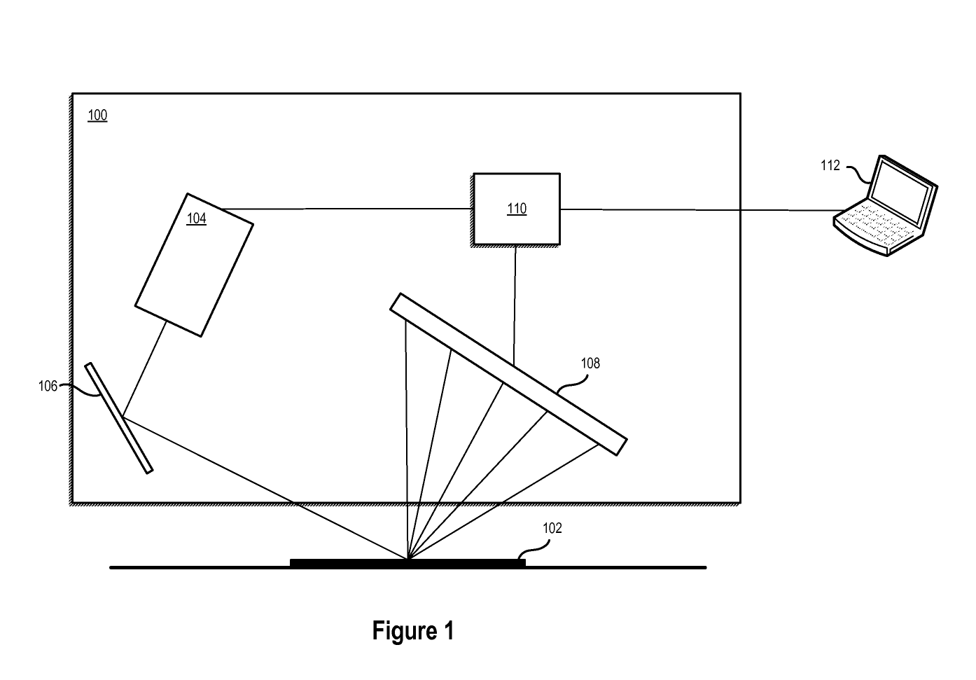

FIG. 1 illustrates a block diagram of a non-contact optical surface roughness measurement device 100. The illustrated non-contact optical surface roughness measurement device 100 is configured to measure the roughness of a surface 102 based on measuring the relative distribution of reflected light and scattered light from the surface 102 using, for example, techniques described in the '527 patent.

The non-contact optical surface roughness measurement device 100 may include a coherent light source 104 that, in some embodiments, may be a laser having a nominal output wavelength of 650 nm. The output of the coherent light source 104 may be directed towards one or more reflective surfaces 106 configured to re-direct the output to a surface 102 being measured by the device 100. In certain embodiments, the reflective surfaces 106 may include mirrors, prisms, or any other suitable optical components, and may be configured to direct the output of the coherent light source 104 towards the surface 102 at a desired incident angle (e.g., a shallow angle of incidence). In alternative embodiments, the non-contact optical surface roughness measurement device 100 may not include reflective surfaces 106, but rather may integrate the coherent light source 104 in an orientation where its output is directed towards the surface at variable incident angles.

After contacting the surface 102, the output of the coherent light source 104 may be reflected and scattered to one or more arrays of detectors 108. In certain embodiments, the detectors 108 may include one or more photodiode components configured to measure light incident upon the detectors 108. The detectors 108 may be configured to detect a distribution of reflected light and a distribution of scattered light from the surface 102. Based on the relative distributions of reflected and scattered light incident upon the detectors 108, information relating to the roughness of the surface 102 may be calculated using the techniques described in the '527 patent. In certain embodiments, the calculated information relating to the roughness of the surface 102 may be a roughness parameter characterizing the surface based on the vertical deviations of the roughness profile of the surface from a mean line (e.g., an Ra or RMS roughness factor) or may be related to numerous other roughness parameters characterizing the surface such as, for example, roughness slope and roughness spacing. In some embodiments, the non-contact optical surface roughness measurement device 100 may be calibrated using varying techniques including, for example, the calibration techniques discussed in U.S. patent application Ser. No. 13/083,130 (“the '130 application”), filed Apr. 8, 2011, which is herein incorporated by reference in its entirety.

Internal electronics 110 and/or an external control system 112 may control the operation of the non-contact optical surface roughness measurement device 100. In certain embodiments, internal electronics 110 and/or external control system 112 may be configured to communicatively interface with the coherent light source 104, the detectors 108, and any other component of the measurement device 100. In some embodiments, external control system 112 may provide a user interface for a user to provide control information to and receive measurement information from the non-contact optical surface roughness measurement device 100.

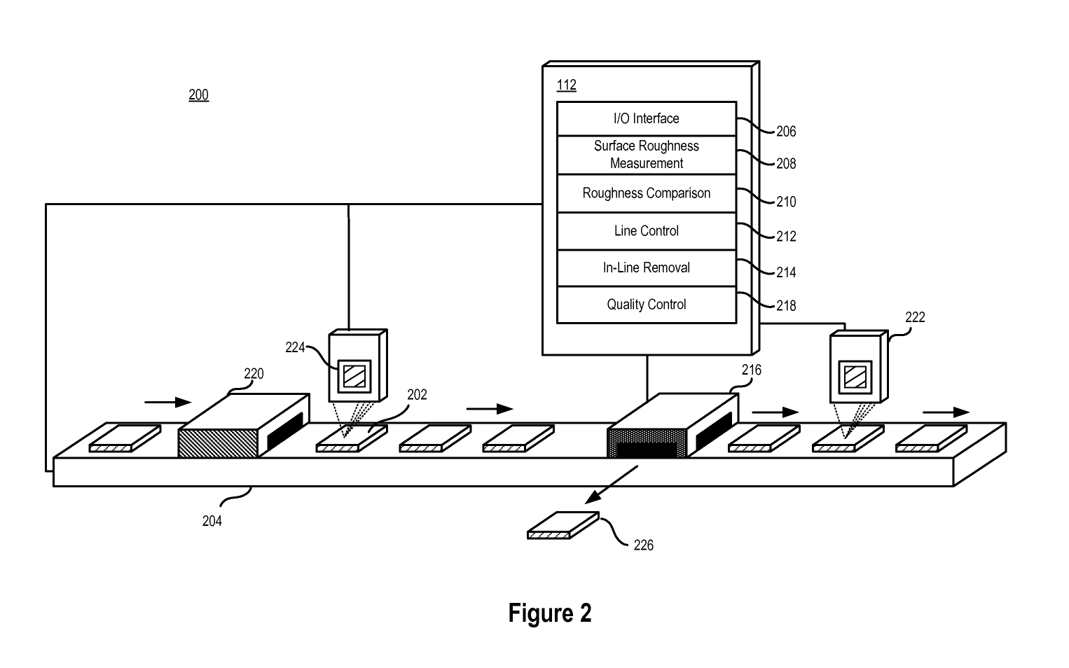

FIG. 2 illustrates a block diagram of an in-process non-contact optical surface roughness measurement system 200. The illustrated in-process non-contact optical surface roughness measurement system 200 is configured to measure the surface roughness of one or more target surfaces 202 of a workpiece during a manufacturing process using a non-contact optical surface roughness measurement device 100, as illustrated and detailed in reference to FIG. 1. In certain embodiments, the non-contact optical surface roughness measurement device 100 may be positioned following a surface shaping and/or profiling device 220 designed to change the texture and/or micro-roughness of a workpiece (e.g., via etching, shaping, profiling, machining, forming, grinding, electroplating, coating, spraying, electroforming, etc.) as a part of the manufacturing process along a manufacturing line 204.

The non-contact optical surface roughness measurement device 100 may be integrated into the system 200 at a location that allows the measurement device 100 to measure one or more target surfaces 202 of workpiece as the target surfaces 202 continuously move along the manufacturing line 204. By integrating surface roughness measurement of target surfaces 202 of workpiece as they continuously move along the manufacturing line 204, the manufacturing process may continue without significant interruption attributed to surface roughness measurement. In alternative embodiments, the non-contact optical surface roughness measurement device 100 may measure the one or more target surfaces 202 as the target surfaces 202 temporarily stop moving at the certain location along the manufacturing line 204 for measurement. Further, in some embodiments, the non-contact optical surface roughness measurement device 100 may be moved relative to the one or more target surfaces 202 (e.g., via a track system or the like) and the one or more target surfaces 202 under measurement may remain stationary. In certain embodiments, the manufacturing line 204 may comprise one or more conveyer systems, railways, monorails, automated guided vehicles and/or any other automated or non-automated material handling system designed to move the devices including target surfaces 202 between process tools in a manufacturing process. In some embodiments, the non-contact optical surface roughness measurement device 100 may be integrated into one or more process tools included in the system.

In some embodiments, the one or more target surfaces 202 and/or workpieces may be a continuous material rather than discrete target surfaces 202 and/or workpieces as illustrated in FIG. 2. For example, in certain embodiments, the one or more target surfaces 202 may be included on a continuous sheet of material (e.g., a planar sheet of material) and/or a wire (e.g., a guide wire microwire used for insertion a medical stent).

The manufacturing line 204 and/or the non-contact optical surface roughness measurement device 100 may be controlled in part by an external control system 112 communicatively coupled to the manufacturing line 204 and/or the non-contact optical surface roughness measurement device 100. In certain embodiments, the external control system 112 may operate separately from or in conjunction with internal control systems (e.g., internal electronics 110) included in the non-contact optical surface roughness measurement device 100. In some embodiments, the manufacturing line 204 and the non-contact optical surface roughness measurement device 100 may be independently controlled. Further, in some embodiments, the non-contact optical surface roughness measurement device 100 may be controlled at least in part by an interface 224 (e.g., a touch screen display or the like) integrated into the non-contact optical surface roughness measurement device 100 and/or the external control system 112. In certain embodiments, the interface 224 may display measured roughness information and parameter substantially concurrent with the measurements, thereby providing a real-time or near-real-time indication of measured roughness information of a target surface 202 to a user on a manufacturing shop floor.

The external control system 112 may include any suitable combination of hardware, software, and/or firmware components configured to implement the systems and methods for in-process non-contact optical surface roughness measurements disclosed herein. In some embodiments, the external control system 112 may comprise a general purpose computer device, such as a personal computer or a network server, and/or a specialized computing device such as a programmable logic controller (PLC). The external control system 112 may include: one or more processors; one or more non-transitory storage mediums, which may include high speed random access memory (RAM), non-volatile memory (ROM), and/or one or more bulk non-volatile computer-readable storage mediums (e.g., a hard disk, flash memory, etc.), for storing computer programs and other data for use and execution by the processor(s); one or more ports for interfacing with removable memory that may include one or more diskettes, optical storage mediums (e.g., flash memory, thumb drives, USB dongles, compact discs, DVDs, etc.) and/or other computer-readable storage mediums; input/output (I/O) interface(s) 206 for communicating with other systems and components (e.g., non-contact optical surface roughness measurement device 100, manufacturing line 204, and/or an in-process ejector 216, described in detail below) via a network such as, for example, the Internet, a local area network, a virtual private network, and the like using one or more communication technologies (e.g., wireless, Ethernet, and/or the like); a user interface that may include a display and/or one or more user input devices such as, for example, a touchscreen, a keyboard, a mouse, a track pad, and the like; and one or more busses for communicatively coupling the elements of the external control system 112.

Methods for in-process non-contact optical surface roughness measurement consistent with embodiments disclosed herein may be achieved through one or more software implementations that may include one or more computer programs comprising executable code/instructions that, when executed by a processor of the external control system 112, cause the processor to perform a method defined at least in part by the executable instructions. The computer program can be written in any form of programming language, including compiled or interpreted languages, and can be deployed in any form, including as a standalone program or as one or more executable functional modules, components, subroutines, or other units suitable for use in a computing environment. Further, a computer program can be deployed to be executed on one computer or on multiple computers at one site or distributed across multiple sites and interconnected by a communication network. Software embodiments disclosed herein may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory memory and/or storage device.

The external control system 112 may execute a line control module 212 configured to interface with the manufacturing line 204 and control, at least in part, certain aspects of the manufacturing line 204. For example, using the line control module 212, the external control system 112 may control a speed of the manufacturing line 204, one or more process tools in the manufacturing line 204, and/or the relative position of one or more of the target surfaces 202 on the manufacturing line 204. In further embodiments, the line control module 212 may allow the external control system 112 to interface with one or more sensors and/or detectors (e.g., optical sensors, acoustic sensors, mechanical sensors, etc.) included in the manufacturing line 204 that, in certain embodiments, may provide the line control module 212 with an indication of the relative position of one or more of the target surfaces 202 along the manufacturing line 204.

In some embodiments, the external control system 112 may execute a surface roughness measurement module 208 configured to interface with the non-contact optical surface roughness measurement device 100 via the I/O interface 206 and control, at least in part, the operation of the device 100. For example, in certain embodiments, the surface roughness measurement module 208 may control the non-contact optical surface roughness measurement device 100 to measure the surface roughness of a target surface 202 in a measurement position on the manufacturing line 204 and provide an indication of the measured surface roughness to the external control system 112. In some embodiments, a target surface 202 may be determined to be in a measurement position based on information received from one or more sensors and/or detectors included in the manufacturing line 204. In certain embodiments, the non-contact optical surface roughness measurement device 100 may be integrated into the system 200 such that it is at a predetermined distance from a target surface 202 in a measurement position on the manufacturing line 204 that allows for accurate, repeatable, reproducible, and verifiable measurement of the surface roughness of the target surface 202. In certain embodiments, the external control system 112 receive information regarding the actual relative distance between the target surface 202 and the non-contact optical surface roughness measurement device 100 and may vary the actual distance to be closer to the predetermined distance by directing a mechanical system (e.g., a mechanical actuator and/or translation stage) to move the target surface 202 and/or the non-contact optical surface roughness measurement device 100. In this manner, negative effects attributable to minor vibrations and/or change in the actual relative distance from the predetermined distance may be reduced (e.g., less accurate and repeatable measurements). Moreover, in further embodiments, the non-contact optical surface roughness measurement device 100 may be calibrated such that the indication of the measured surface roughness is accurate, repeatable, reproducible, and verifiable within certain specified manufacturing tolerances.

The measured surface roughness of a target surface 202 may be utilized by a roughness comparison module 210 executing on the external control system 112 to compare the measured surface roughness with one or more predetermined surface roughnesses and/or ranges of predetermined surface roughnesses (i.e., control and/or tolerance limits having lower surface roughness values). In some embodiments, the one or more predetermined surface roughnesses and/or ranges of predetermined surface roughnesses may be related to manufacturing specifications and/or tolerances for surface roughnesses of the target surfaces 202. Based on the comparison, the roughness comparison module 210 may determine whether the measured surface roughness of the target surface 202 is within, or alternatively outside of, the one or more predetermined surface roughnesses and/or ranges of predetermined surface roughnesses.

In some embodiments, if a measured surface roughness of the target surface 202 is within the one or more predetermined surface roughnesses and/or ranges of predetermined surface roughnesses, the target surface 202 may be considered to be within manufacturing specifications and/or tolerances for surface roughnesses. In circumstances where a measured surface roughness of the target surface 202 has exceeded one or more predetermined surface roughnesses and/or is outside one or more ranges of predetermined surface roughnesses, the target surface 202 may be considered to be out of manufacturing specifications and/or tolerances for surface roughnesses.

When a measured surface roughness of a target surface 202 is determined to be outside the one or more predetermined surface roughnesses and/or ranges of predetermined surface roughnesses based on the comparison made by the roughness comparison module 210, an in-line removal control module 214 may direct an in-process ejector 216 to remove the out-of-specification target surface 226 from the manufacturing line 204. In certain embodiments, the in-process ejector 216 may include any electro-mechanical and/or pneumatic mechanism configured to remove a target surface 202 from the manufacturing line 204. In certain embodiments, the in-process ejector 216 may remove an out-of-specification target surface 226 substantially simultaneous to measuring the surface roughness of another target surface in position for measurement by the non-contact optical surface roughness measurement device 100 along the manufacturing line 204. By removing an out-of-specification target surface 226 from the manufacturing line 204, potentially defective target surfaces 202 may be prevented from continuing through the manufacturing process, thereby reducing costs.

Data related to measured surface roughnesses of target surfaces 202 on workpieces along the manufacturing line 204 may also be collected by a quality control module 218. In certain embodiments, the quality control module 218 may associate information related to measured surface roughnesses with identification information related to one or more workpieces including the measured target surfaces 202. This information may be used in generating data for which workpieces are within manufacturing specifications and/or tolerances, what percentage of workpieces of within manufacturing specifications and/or tolerances, and the like, which may be used for quality control purposes. In certain embodiments, data collected and/or generated by the quality control module 218 may be exported from the external control system 112 in, for example, real time, to be utilized by other external systems for quality control purposes.

Other functional modules may execute on the external control system 112. For example, in certain embodiments, the external control system 112 may execute a module configured to store a series of measured surface roughnesses and calculate an average measured surface roughness from the series of measured surface roughnesses. In certain embodiments, the calculated average measured roughness may be a calculated average roughness for a single continuous workpiece (e.g., a wire) or calculated average across multiple workpieces. Similarly, the external control system 112 may execute a module configured to calculate running standard deviations of measured surface roughnesses, average and actual roughnesses for a batch of work pieces, a number and/or percentage of workpieces in a batch of workpieces within manufacturing specifications and/or tolerances, and/or a number and/or percentage of workpieces in a batch of workpieces that are outside of manufacturing specifications and/or tolerances. In some embodiments, this calculated information may be displayed in real-time or near real-time on an interface (e.g., interface 224 or I/O interface 206).

By integrating surface roughness measurement using an non-contact optical surface roughness measurement device 100 within a manufacturing line 204, surface roughness measurement may be performed on a shop floor without requiring the use of manual fixed and/or portable profilometers devices, thereby expediting the manufacturing process and/or reducing costs. In this manner, accurate repeatable, reproducible, and verifiable surface roughness measurement results make be taken in a shop and/or manufacturing working environment. Moreover, utilizing a non-contact optical surface roughness measurement device 100 in the system 200 may substantially reduce any measurement errors caused by vibration in a shop environment than errors than those that could potentially be introduced if a conventional mechanical profilometer was utilized.

Other non-contact optical surface roughness measurement devices similar to device 100 may be included in the in-process non-contact optical surface roughness measurement system 200 illustrated in FIG. 2. For example, as illustrated, a second non-contact optical surface roughness measurement device 222 may be included in the in-process non-contact optical surface roughness measurement system 200 in a different location along the manufacturing line 204 than non-contact optical surface roughness measurement device 100. The second non-contact optical surface roughness measurement device 222 may be controlled in part by the external control system 112 and/or independently controlled as described above in reference to device 100. In certain embodiments, calculations relating to the measured surface roughnesses of the one or more target surfaces (e.g., average surface roughnesses and the like) may be based on measured surface roughnesses obtained from more than one non-contact optical surface roughness measurement device (e.g., device 100 and 222).

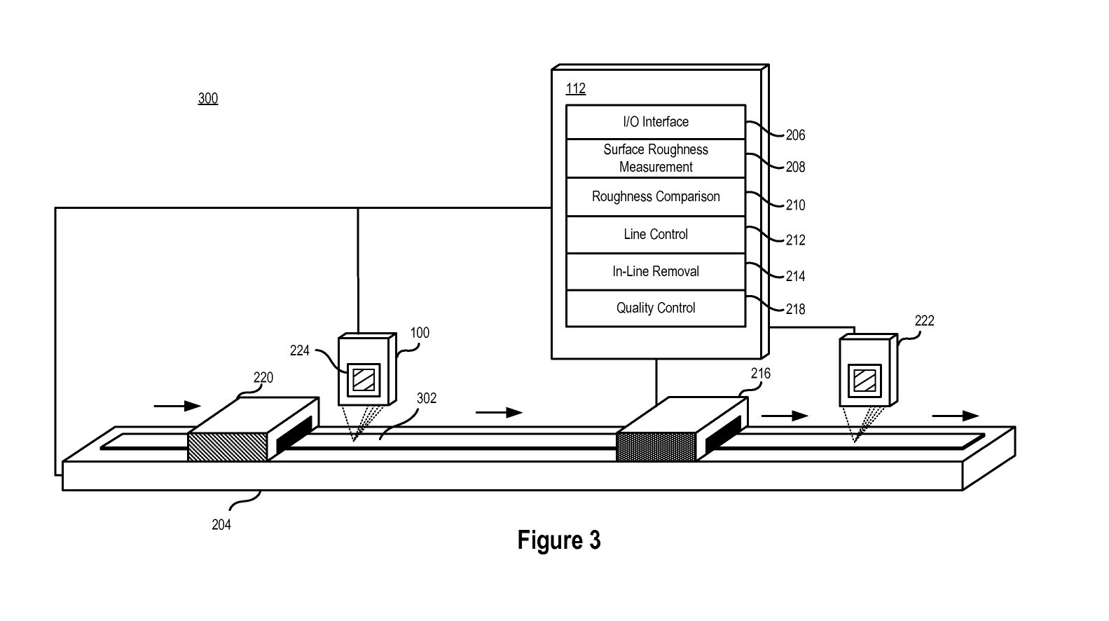

FIG. 3 illustrates a block diagram of an in-process non-contact optical surface roughness measurement system 300 configured to measure a continuous sheet of material 302. The illustrated in-process non-contact optical surface roughness measurement system 300 is similar to the in-process non-contact optical surface roughness measurement system 200 illustrated in FIG. 2, but is specifically configured to measure a workpiece comprising a continuous sheet of material 302. In certain embodiments, the continuous sheet of material 302 may be a substantially planar sheet of material such as, for example, a sheet of metal. In embodiments where the continuous sheet of material 302 is sheet metal, the in-process non-contact optical surface roughness measurement system 300 may be utilized to determine whether the surface of the metal has no greater than a defined level of surface roughness based on manufacturing specifications.

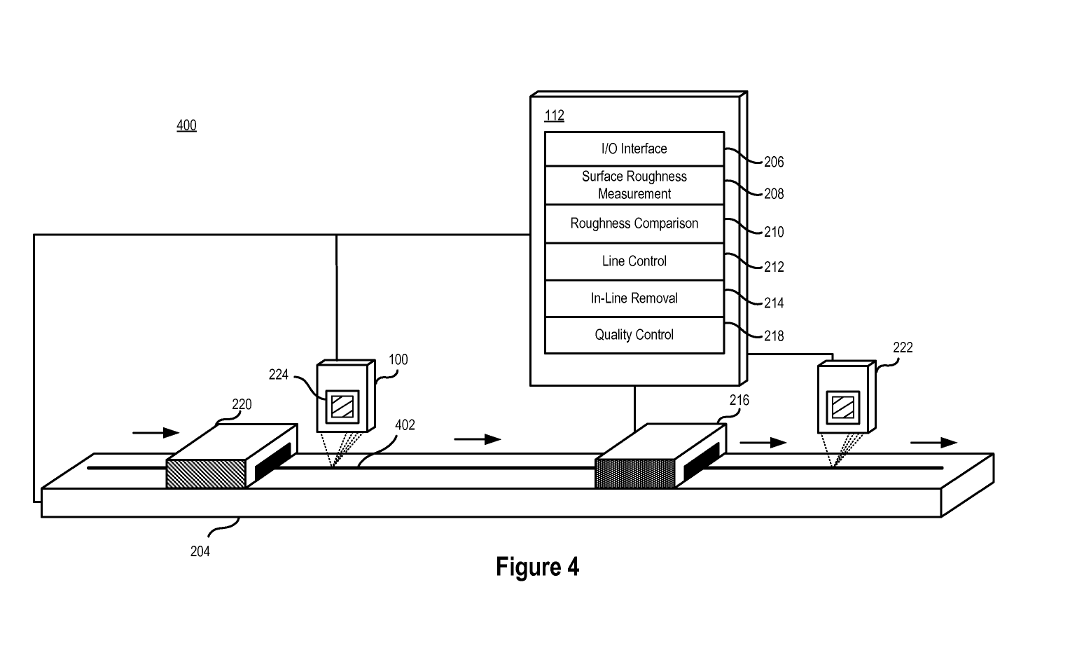

FIG. 4 illustrates a block diagram of an in-process non-contact optical surface roughness measurement system 400 configured to measure a continuous wire 402. The illustrated in-process non-contact optical surface roughness measurement system 400 is similar to the in-process non-contact optical surface roughness measurement systems 200, 300 illustrated respectively in FIGS. 2-3, but is specifically configured to measure a workpiece comprising a continuous wire 402. In certain embodiments, the continuous wire 402 may be a continuous wire (e.g., a microwire or guide wire) used for insertion of a medical stent. The non-contact optical surface roughness measurement device 100 included in the system 400 may be capable of measuring surface roughness of a target surface that is both larger and smaller than its measurement “spot” size, enabling it to measure materials (e.g., continuous wires and/or guide wires) of relatively small size and/or diameter. For example, a continuous wire (e.g., wire 402) extending through the measurement “spot” can be measured (e.g., continuously measured and/or measured in a stationary manner), allowing for surface roughness measurement of an entire length of wire of variable lengths. Wires of varying diameters may also be similarly measured, including wires of diameters much larger than the measurement “spot” size of the non-contact optical surface roughness measurement system 400.

In certain embodiments, surfaces having both large and small diameter curvatures may be measured by the non-contact optical surface roughness measurement device 100. For example, shafts and pins of varying diameters may be measured. Further, the non-contact optical surface roughness measurement device 100 may be positioned in various orientations relative to a workpiece under measurement (e.g., continuous wire 402). Moreover, in some embodiments, the non-contact optical surface roughness measurement device 100 may be operated to take multiple measurements of a single worksheet.

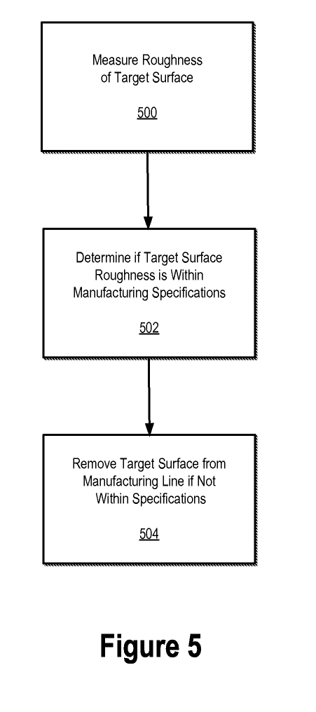

FIG. 5 illustrates a flow diagram of an exemplary method for in-process non-contact optical surface roughness measurement consistent with embodiments disclosed herein. In certain embodiments, the exemplary method may be implemented using a system similar to the systems 200, 300, 400 detailed above in reference to FIGS. 2-4. Using a fixed non-contact optical surface roughness measurement device 100, the roughness of a target surface 202 may be measured 500 as it moves into a measurement position under the fixed non-contact optical surface roughness measurement device 100 along a manufacturing line 204.

After measuring the surface roughness of the target surface 202, a determination 502 may be made if the target surface roughness is within, or alternatively outside of, the one or more predetermined surface roughnesses and/or ranges of predetermined surface roughnesses. Based on this determination, it may be determined whether the measured target surface 202 is within manufacturing specifications and/or tolerances for surface roughness. If the measured target surface 202 is not within manufacturing specifications and/or tolerances for surface roughness, the target surface 202 may be removed 504 from the manufacturing line 204 using an in-process ejector 216 (e.g., an electromechanical mechanism or the like). Alternatively, in certain embodiments, if the measured target surface 202 is not within manufacturing specifications and/or tolerances for surface roughness, the workpiece including the target surface 202 may be characterized as a “lower” grade workpiece. In such embodiments, the “lower” grade workpiece may be removed 504 from the manufacturing line 204 and be either scrapped, salvaged, or sold as a lower grade material (e.g., in developing markets with lower standards and/or tolerances).

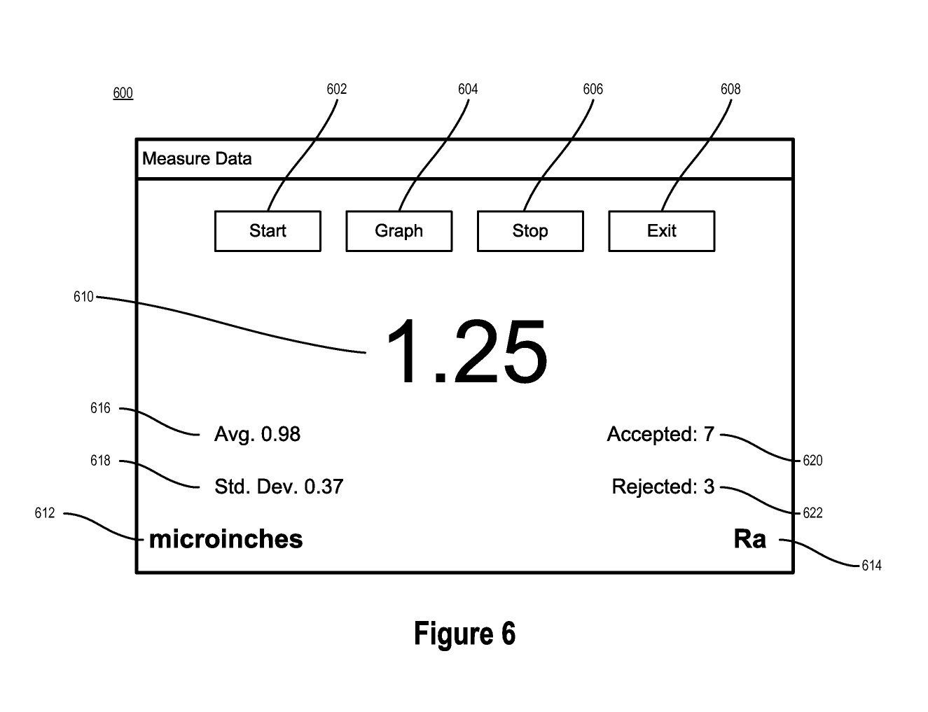

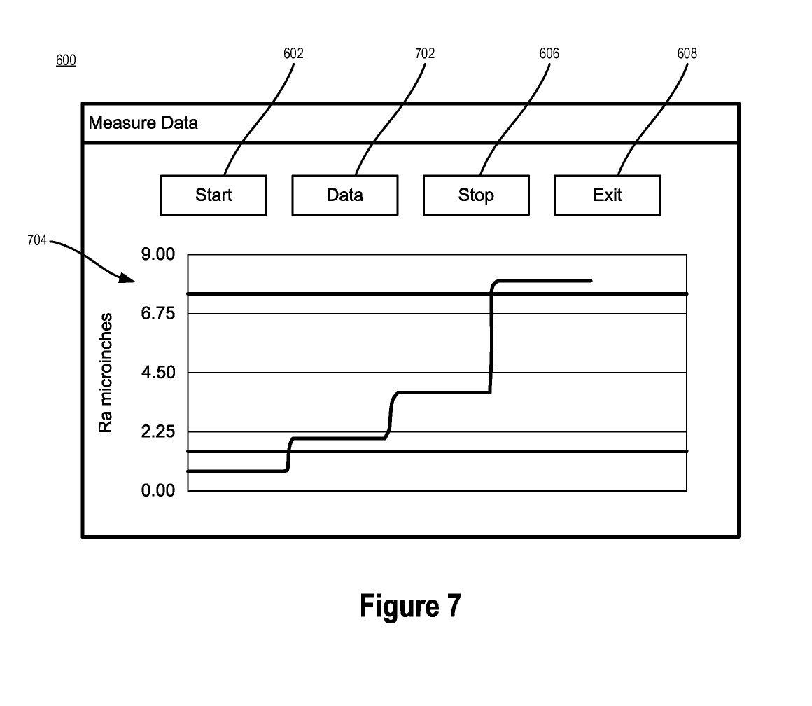

FIGS. 6 and 7 illustrate exemplary screenshots 600, 700 of a display of an external control system for an in-process non-contact optical surface roughness measurement device consistent with embodiments disclosed herein. Particularly, FIGS. 6 and 7 illustrate a screenshot 600 presenting measurement data in a numerical format and a screenshot 700 presenting measurement data in a graphical format. In certain embodiments, the display may be a touch screen display and a user may interface with the external control system using one or more virtual buttons 602-608 displayed on the touch screen. For example, the touch screen my display a start button 602 for initiating a measurement and/or series of measurements, a graph button 604 for displaying a screenshot 700 presenting measurement data in a graphical format, a data button 702 for displaying a screenshot 600 presenting measurement data in a numerical format, a stop button 606 for terminating a measurement and/or series of measurements, and/or an exit button 608 for exiting the screenshots 600, 700 (e.g., returning a user to a main menu, a settings menu, or the like).

Screenshot 600 may present real time measurement data in a numerical format 610. A indication of measurement type 614 and/or unit of measurement 612 may also be displayed to provide context to the displayed measurement data 610. In certain embodiments, an indication of a running average 616 and/or a standard division 618 of current and prior measurements may also be displayed. Further, an indication of a number 620 of workpieces found to be within manufacturing tolerances and/or specifications (e.g., accepted) and a number 622 of workpieces found to be outside of manufacturing tolerances and/or specifications (e.g., rejected 3) may be displayed. Screenshot 700 may provide similar information in a graphical format 704 indicating current and/or prior measurement data.

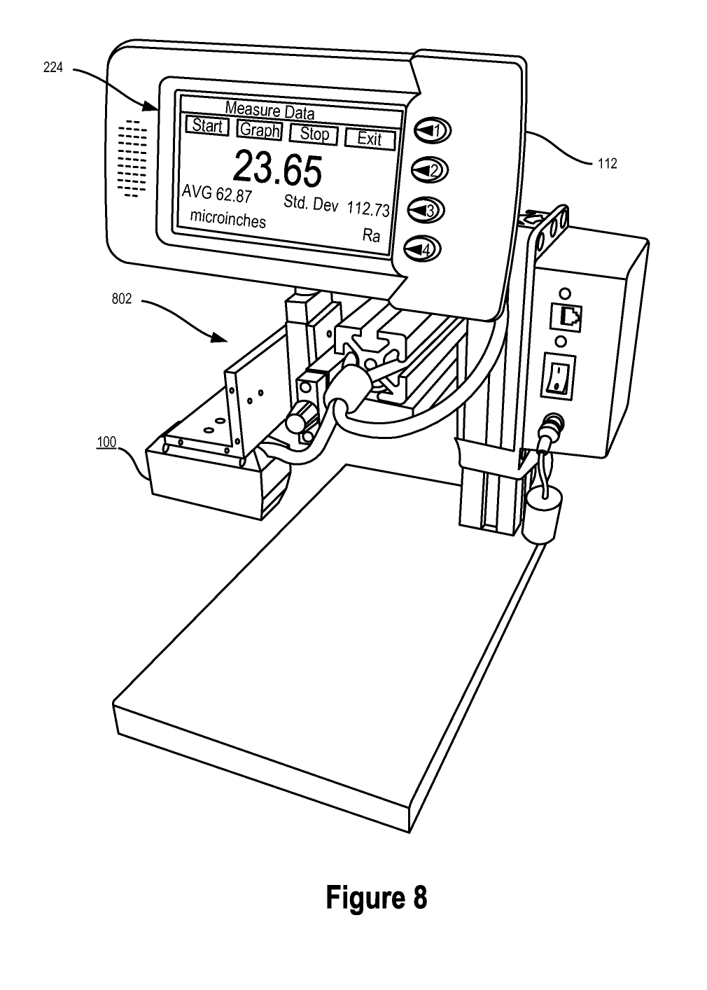

FIG. 8 illustrates a non-contact optical surface roughness measurement device 100 affixed to a adjustable mount 800 consistent with embodiments disclosed herein. The non-contact optical surface roughness measurement device 100 may be controlled by an external control system 112. The external control system may include by an interface 224 (e.g., a touch screen display or the like) allowing an user to interface (e.g., provide control instructions to and receive measurement data from) the non-contact optical surface roughness measurement device 100. The adjustable mount 800 may allow the non-contact optical surface roughness measurement device 100 to be moved and/or positioned relative to a manufacturing line (not shown). For example, as discussed above, the non-contact optical surface roughness measurement device 100 may provide accurate and repeatable measurement information when it is positioned in a predetermined position and/or at a predetermined distance from a target surface being measured. The non-contact optical surface roughness measurement device 100 may detect an actual relative position and/or distance from the target surface, and the adjustable mount 800 may be controlled by the external control system 112 to translate the measurement device from the actual relative position and/or distance from the target surface to the predetermined position and/or predetermined distance from the target surface, thereby ensuring accurate, repeatable, reproducible, and verifiable measurement information.

Many changes may be made to the details of the above-described embodiments without departing from the underlying principles of this disclosure. The scope of this disclosure should, therefore, be determined only by the following claims.

What is claimed is:

1. A system for measuring the roughness of a first target surface of a first workpiece comprising:
a manufacturing line configured to provide movement of the first workpiece through a manufacturing process along the manufacturing line;
a non-contact optical surface roughness measurement device configured to measure the surface roughness of the first target surface of the first workpiece on the manufacturing line at a measurement location while the first workpiece is moving along the manufacturing line; and
a control system communicatively coupled with the non-contact optical surface roughness measurement device and configured to receive an indication of a measured surface roughness of the first target surface of the first workpiece from the non-contact optical surface roughness measurement device.

2. The system of claim 1, wherein the measurement location is at a predetermined distance relative to the non-contact optical surface roughness measurement device.

3. The system of claim 2, wherein the non-contact optical surface roughness measurement device is further configured to determine a distance between the measurement location and the non-contact optical surface roughness measurement device and the system further comprises a mechanical actuator configured to adjust the distance between the measurement location and the non-contact optical surface roughness measurement device to the predetermined distance.

4. The system of claim 1, wherein the non-contact optical surface roughness measurement device is configured to measure a relative distribution of reflected light and scattered light from the first target surface of the first workpiece to determine a measured surface roughness of the first target surface.

5. The system of claim 1, wherein the control system is configured to determine whether the indication of the measured surface roughness of the first target surface is less than a predetermined surface roughness, greater than the predetermined surface roughness, or within a range of predetermined surface roughnesses.

6. The system of claim 1, wherein the system further comprising a profiling tool configured to alter a second target surface of a second workpiece on the manufacturing line.

7. The system of claim 1, wherein the profiling tool is further configured to alter the second target surface of the second workpiece substantially simultaneous to the non-contact optical surface roughness measurement device measuring the surface roughness of the first target surface.

8. The system of claim 1, wherein the predetermined surface roughness or range of predetermined surface roughnesses are related to at least one manufacturing specification for the target surface.

9. The system of claim 5, further comprising an in-line ejector communicatively coupled to the control system configured to remove the first workpiece from the manufacturing line.

10. The system of claim 9, wherein the in-line ejector is further configured to remove the first workpiece from the manufacturing line substantially simultaneous to the non-contact optical surface roughness device measuring the surface roughness of a second target surface or a second workpiece on the manufacturing line.

11. The system of claim 9, wherein the in-line ejector comprises an electromechanical mechanism.

12. The system of claim 9, wherein the control system is configured to direct the in-line ejector to remove the first workpiece from the manufacturing line if the control system determines that the indication of the measured surface roughness of the first target surface is not less than the predetermined surface roughness or within the range of predetermined surface roughnesses.

13. The system of claim 6, wherein the first workpiece and first target surface and second workpiece and second target surface are integrated on a continuous workpiece.

14. The system of claim 13, wherein the continuous workpiece is a planar sheet.

15. The system of claim 13, wherein the continuous workpiece is a wire.

16. The system of claim 1, wherein the first target surface is smaller than a measurement spot size of the non-contact optical surface roughness measurement device.

17. The system of claim 1, wherein the first target surface is larger than a measurement spot size of the non-contact optical surface roughness measurement device.

18. A method for measuring the roughness of a first target surface of a first workpiece comprising:
providing movement of the first workpiece through a manufacturing process along a manufacturing line;
securing a non-contact optical surface roughness measurement device in a position relative to the manufacturing line;
the non-contact optical surface roughness measurement device measuring the surface roughness of the first target surface of the first workpiece on the manufacturing line at a measurement location while the first workpiece is moving along the manufacturing line; and
a control system, communicatively coupled with the non-contact optical surface roughness measurement device, receiving an indication of a measured surface roughness of the first target surface of the first workpiece from the non-contact optical surface roughness measurement device.

19. The method of claim 18, wherein the measurement location is at a predetermined distance relative to the non-contact optical surface roughness measurement device.

20. The method of claim 19, wherein the method further comprises:
moving the non-contact optical surface roughness measurement device relative to the measurement location such the relative distance between the measurement location and the non-contact optical surface roughness measurement device is the predetermined distance.

21. The method of claim 18, further comprising the non-contact optical surface roughness measurement device measuring a relative distribution of reflected light and scattered light from the first target surface of the first workpiece to determine a measured surface roughness of the first target surface.

22. The method of claim 18, further comprising the control system determining whether the indication of the measured surface roughness of the first target surface is less than a predetermined surface roughness, greater than the predetermined surface roughness, or within a range of predetermined surface roughnesses.

23. The method of claim 22, wherein the predetermined surface roughness or range of predetermined surface roughnesses are related to at least one manufacturing specification for the target surface.

24. The method of claim 22, further comprising removing the first workpiece from the manufacturing line if the workpiece is greater than a predetermined surface roughness or outside of a range of predetermined surface roughnesses.

25. The method of claim 18, further comprising altering a second target surface of a second workpiece on the manufacturing line.

26. The method of claim 25, wherein altering the second target surface is performed substantially simultaneously to the non-contact optical surface roughness measurement device measuring the surface roughness of the first target surface.

27. The method of claim 22, further comprising removing the first workpiece from the manufacturing line substantially simultaneous to the non-contact optical surface roughness device measuring the surface roughness of the second target surface of the second workpiece on the manufacturing line.

28. The method of claim 18, wherein the first target surface is smaller than a measurement spot size of the non-contact optical surface roughness measurement device.

29. The method of claim 18, wherein the first target surface is larger than a measurement spot size of the non-contact optical surface roughness measurement device.
